(19) United States
(12) Patent Application Publication
(10) Pub. No.: US 2019/0061803 A1
(43) Pub. Date: Feb. 28, 2019

(54) ELECTRIC STEERING COLUMN APPARATUS

(71) Applicant: FUJI KIKO CO., LTD., Kosai-shi (JP)

(72) Inventors: Kyoichi Inoue, Kosai-shi (JP); Takeshi Miyagi, Kosai-shi (JP); Daisuke Terada, Kosai-shi (JP); Tomoya Ohashi, Kosai-shi (JP)

(21) Appl. No.: 16/109,821

(22) Filed: Aug. 23, 2018

(30) Foreign Application Priority Data
Aug. 28, 2017 (JP) 2017-163047
Aug. 28, 2017 (JP) 2017-163049

(51) Int. Cl. B62D 1/181; B62D 1/189

(52) U.S. Cl. CPC B62D 1/181; F16H 2025/2043; B62D 1/189

(57) ABSTRACT

The link member has a pair of link bodies disposed on both sides of the steering column in the width direction and a linkage portion linking the link bodies. A first through hole is formed in the vehicle-body mounting bracket, a first bottomed hole facing the first through hole is formed at the first connecting portion of the link bodies, a base of a first pin is fixed to the first through hole, and a distal end portion of the first pin is inserted into the first bottomed hole. A second through hole is formed at the second connecting portion of the link bodies, a second bottomed hole facing the second through hole is formed on the steering column, a base of a second pin is fixed to the second through hole, and a distal end portion of the second pin is inserted into the second bottomed hole.

### CROSS REFERENCE TO RELATED APPLICATION

The present application is based on, and claims priority from Japanese Patent Application No. 2017-163047, filed Aug. 28, 2017; and 2017-163049, filed Aug. 28, 2017, the disclosure of which is hereby incorporated by reference herein in its entirety.

### TECHNICAL FIELD

The present invention relates to electric steering column apparatuses.

### BACKGROUND ART

Electric steering column apparatuses have been publicly known conventionally (for example, see Patent Literature 1: Japanese Patent Application Publication No. 2012-126274, Patent Literature 2: Japanese Patent Application Publication No. 2009-6743, Patent Literature 3: Japanese Patent Application Publication No. 2009-190679).

One of electric steering column apparatuses of this kind includes a vehicle-body mounting bracket, a steering column swingably supported by the vehicle-body mounting bracket, and a tilt mechanism driven by an electric motor. In such an electric steering column apparatus, a link is disposed between the vehicle-body mounting bracket and the steering column, and the link is pushed or pulled with the electric motor (driving apparatus) to swing the steering column.

An electric steering column apparatus described in Patent Literature 1 has a pressing mechanism disposed on the vehicle-body mounting bracket and configured to always press the steering column from both sides in the right-left direction to prevent play in the right-left direction. Patent Literature 2 discloses an embodiment for a pressing mechanism.

One of electric steering column apparatuses of this kind includes a vehicle-body mounting bracket, a steering column swingably supported by the vehicle-body mounting bracket, and a tilt mechanism driven by an electric motor. In such an electric steering column apparatus, the steering column is configured to swing in the vehicle up-down direction with a tilt shaft disposed on the front side of the vehicle as the rotational fulcrum.

In an electric steering column apparatus described in Patent Literature 3, at the front end support portion of the steering column is formed a through hole passing through in the right-left direction, and in the side walls of the vehicle-body mounting bracket are formed support holes having the same axis as the through hole. Then, a bolt (tilt pivot shaft) inserted into the support holes and the through hole supports the steering column such that the steering column is swingable with respect to the vehicle-body mounting bracket.

### SUMMARY

In the electric steering column apparatus described in the foregoing Patent Literature 1, the pressing mechanism disposed on the vehicle-body mounting bracket and configured to always press the steering column from both sides in the right-left direction can increase the sliding resistance between the steering column and the vehicle-body mounting bracket. This also raises problems of increasing the part count and decreasing the ease of assembly because of the difficulty in adjustment at assembly.

Hence, an object of the present invention is to provide an electric steering column apparatus that has improved rigidity of the steering column in the right-left direction and a simplified structure, and improves the ease of assembly.

An electric steering column apparatus according to the present invention includes: a vehicle-body mounting bracket; a steering column swingably supported by the vehicle-body mounting bracket; and a tilt mechanism driven by an electric motor. The tilt mechanism has a link member connecting the vehicle-body mounting bracket and the steering column to each other, and the link member integrally has a pair of link bodies disposed on both right and left sides of the steering column and a linkage portion linking the link bodies to each other. The link bodies have a first connecting portion to which the vehicle-body mounting bracket is connected, a second connecting portion to which the steering column is connected, and a third connecting portion to which a shaft portion of the electric motor is connected. A first through hole is formed in the vehicle-body mounting bracket, and a first bottomed hole facing the first through hole is formed at the first connecting portion of the link bodies. A base of a first pin is fixed to the first through hole, a distal end portion of the first pin is inserted into the first bottomed hole, and the distal end portion of the first pin is pressed against a bottom surface of the first bottomed hole. A second through hole is formed at the second connecting portion of the link bodies, and a second bottomed hole facing the second through hole is formed on the steering column. A base of a second pin is fixed to the second through hole, a distal end portion of the second pin is inserted into the second bottomed hole, and the distal end portion of the second pin is pressed against a bottom surface of the second bottomed hole.

The electric steering column apparatus according to the present invention has improved rigidity of the steering column in the right-left direction and a simplified structure, and improves the ease of assembly.

The electric steering column apparatus described in the foregoing Patent Literature 3 has problems that when the bolt inserted into the support holes and the through hole is tightened with a nut, the tightening torque of the nut needs to be controlled, and that the adjustment at assembly is difficult and this decreases the ease of assembly.

Thus, an object of the present invention is to provide an electric steering column apparatus that has a simplified structure of the tilt axis (pivot axis) and improves the ease of assembly.

An electric steering column apparatus according to the present invention includes: a vehicle-body mounting bracket; a steering column swingably supported by the vehicle-body mounting bracket; and a tilt mechanism driven by an electric motor. The vehicle-body mounting bracket integrally has a bracket body and a pair of side walls extending from the bracket body and disposed both right and left sides of a swing support portion of the steering column. A column through hole is formed at the swing support portion of the steering column so as to pass through the swing support portion in a right-left direction, and a support hole facing the column through hole is formed in each of the side walls of the vehicle-body mounting bracket. A shaft pin is inserted into the support holes and the column through hole, and a collar member is interposed between an outer peripheral surface of at least one end portion of the shaft pin and an inner peripheral surface of the corresponding support hole. A circumferential groove is formed at least at one end portion of the shaft pin, and an engagement protrusion engaged with the circumferential groove is formed on the collar member.

The electric steering column apparatus according to the present invention has a simplified structure of the tilt axis (pivot axis) and improves the ease of assembly.

### BRIEF DESCRIPTION OF DRAWINGS

FIG. 1 is a perspective view of an electric steering column apparatus according to an embodiment of the present invention.

FIG. 2 is an exploded perspective view of the electric steering column apparatus according to the embodiment of the present invention.

FIG. 3 is a front view of the electric steering column apparatus according to the embodiment of the present invention.

FIG. 4 is a side view of the electric steering column apparatus according to the embodiment of the present invention.

FIG. 5 is a cross-sectional view taken along line A-A in FIG. 4.

FIG. 6 is a cross-sectional view taken along line B-B in FIG. 4.

FIG. 7 is a cross-sectional view taken along line C-C in FIG. 4.

### DESCRIPTION OF EMBODIMENTS

Hereinafter, an embodiment of the present invention will be described in detail with reference to the drawings.

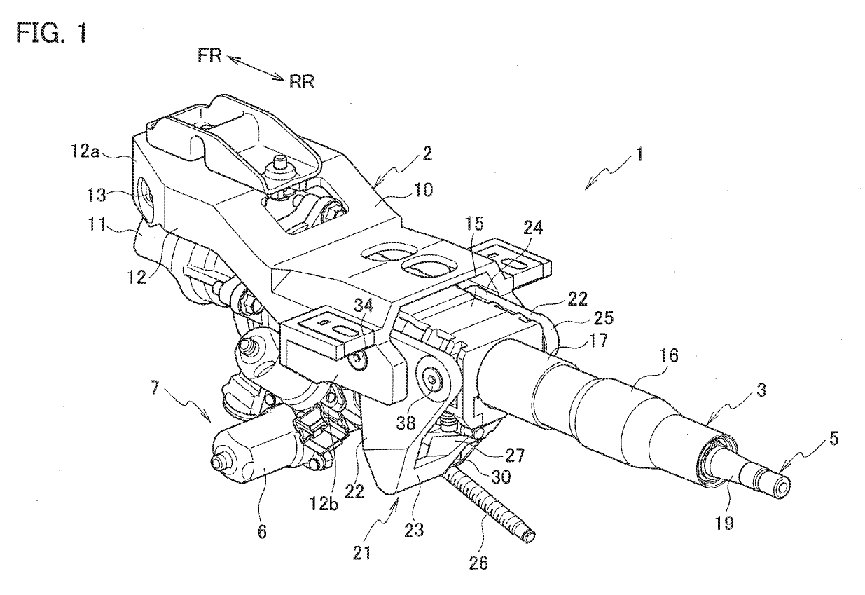

Note that in FIG. 1, arrow FR indicate the vehicle front direction, and arrow RR indicates the vehicle rear direction.

As illustrated in FIGS. 1 to 4, an electric steering column apparatus 1 includes a vehicle-body mounting bracket 2 fixed to the vehicle body and a steering column 3 swingably supported by the vehicle-body mounting bracket 2 in the vehicle up-down direction.

The electric steering column apparatus 1 also includes a steering shaft 5 rotatably supported by the steering column 3 and having a rear end to which a steering wheel 4 is connected and a tilt mechanism 7 driven by an electric motor 6.

The vehicle-body mounting bracket 2 has a bracket body 10 and a pair of side walls 12, 12 extending downward from the bracket body 10 and disposed on both left and right sides of a swing support portion (front end support portion) 11 of the steering column 3. The bracket body 10 and the pair of side walls 12, 12 are formed integrally. The bracket body 10 extends in the vehicle front-rear direction and is fixed to the vehicle body. Each side wall 12 extends in the vehicle front-rear direction, like the bracket body 10. At a vehicle front end portion 12a of the side wall 12 is formed a support hole 13, and a vehicle rear end portion 12b of the side wall 12 is formed a through hole (a first through hole) 14. The support hole 13 formed at the vehicle front end portions 12a of the side wall 12 is an elongated hole extending in the vehicle front-rear direction (the axial direction of the steering column 3). The vehicle-body mounting bracket 2 is, for example, a die-cast product (aluminum cast product) made of aluminum or an aluminum alloy.

The steering column 3 has a tubular outer jacket 15, a tubular inner jacket 16 inserted inside the outer jacket 15 so as to be relatively axially movable, and a mid jacket 17 interposed between the outer jacket 15 and the inner jacket 16. The outer jacket 15 is, for example, a die-cast product (aluminum cast product) made of aluminum or an aluminum alloy.

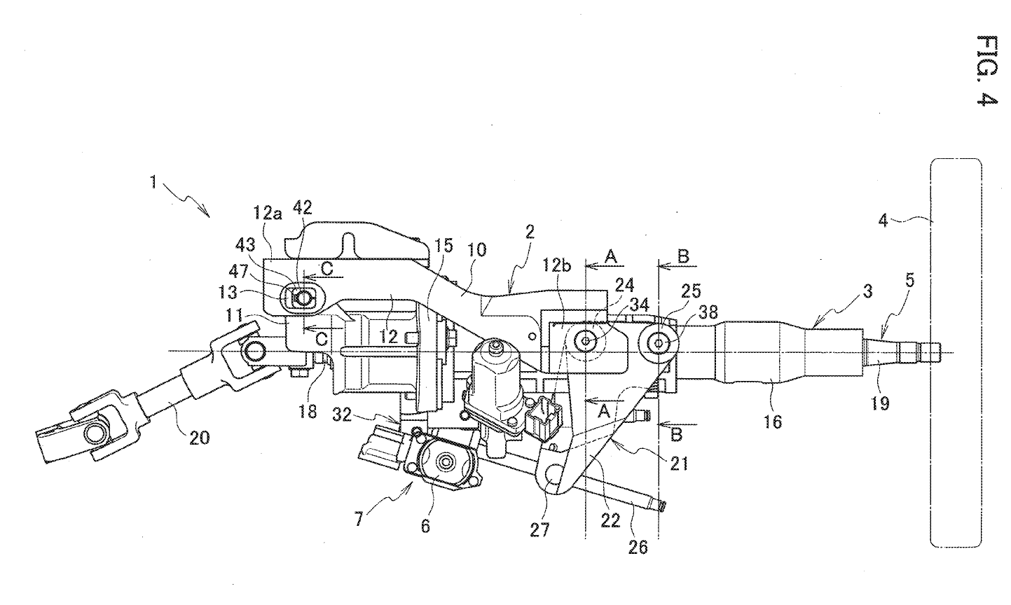

The steering shaft 5 includes a lower shaft 18 (see FIG. 4) on the steered wheel side and an upper shaft 19 connected to the steering wheel 4, and the lower shaft 18 and the upper shaft 19 are connected to each other in a state where the relative rotation is restricted but the relative axial movement is allowed. The upper shaft 19 is rotatably supported by the steering column 3 via bearings (not illustrated). To the front end of the lower shaft 18 is connected a universal joint 20 (see FIG. 4).

Next, the tilt mechanism 7 will be described.

The tilt mechanism 7 has a link member 21 connecting the vehicle-body mounting bracket 2 and the steering column 3 to each other.

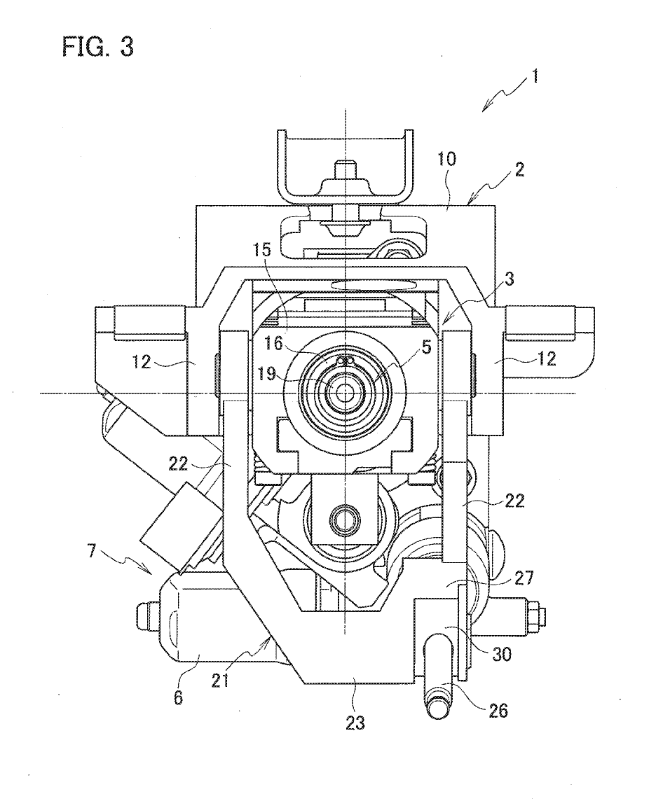

The link member 21 integrally has a pair of link bodies 22, 22 disposed on both right and left sides of the steering column 3 and a linkage portion 23 linking the link bodies 22, 22 to each other. Each link body 22 is formed in a triangular shape in side view. This link body 22 has a first connecting portion (first corner) 24 to which the vehicle-body mounting bracket 2 is connected, a second connecting portion (second corner) 25 to which the steering column 3 is connected, and a third connecting portion (third corner) 27 to which a screw shaft 26 of the electric motor 6 is connected. At the first connecting portion 24 is formed the bottomed hole (first bottomed hole) 28 having the same axis as the first through hole 14 of the vehicle-body mounting bracket 2 and opposed thereto. At the second connecting portion 25 is formed a through hole (second through hole) 29. At the third connecting portion 27, a screw nut 30 (see FIG. 3) with which the screw shaft 26 is threadedly engaged is rotatably supported on the axis in the right-left direction. The link member 21 is, for example, a die-cast product (aluminum cast product) made of aluminum or an aluminum alloy.

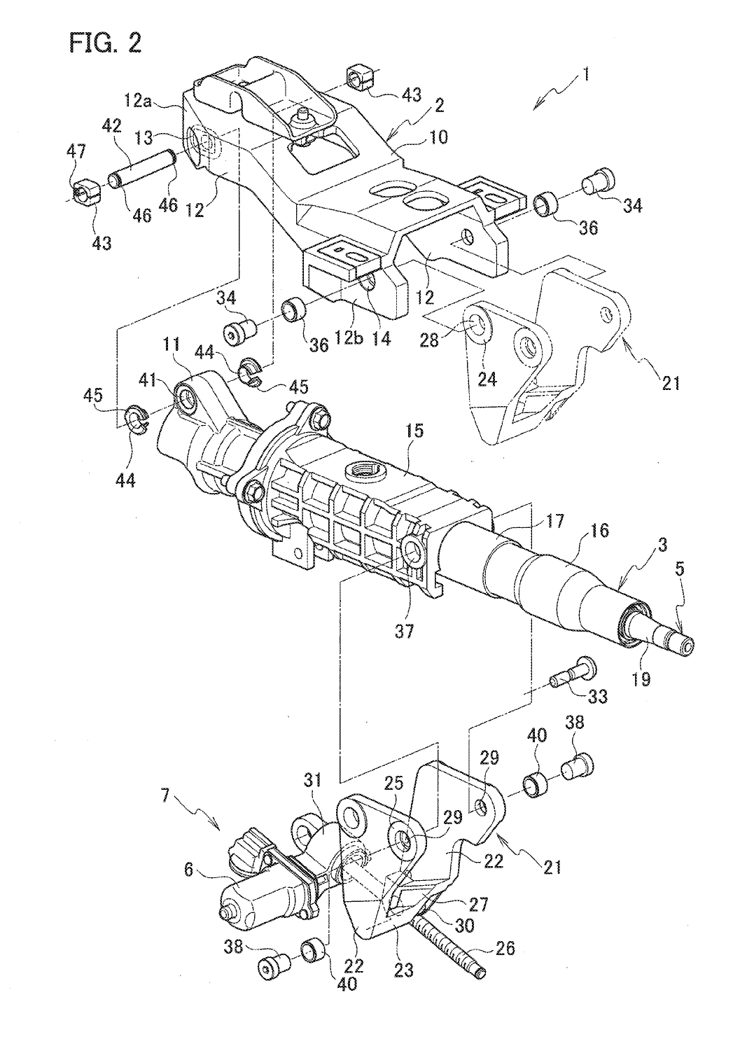

The electric motor 6 is equipped with a speed reduction gear mechanism 31 and the screw shaft 26, and the screw shaft 26 is threadedly engaged with the screw nut 30 rotatably supported by the third connecting portion 27 of the link body 22. The electric motor 6 is rotatably supported by a motor support portion 32 (see FIG. 4) formed below the outer jacket 15, using a motor support pin 33 (see FIG. 2).

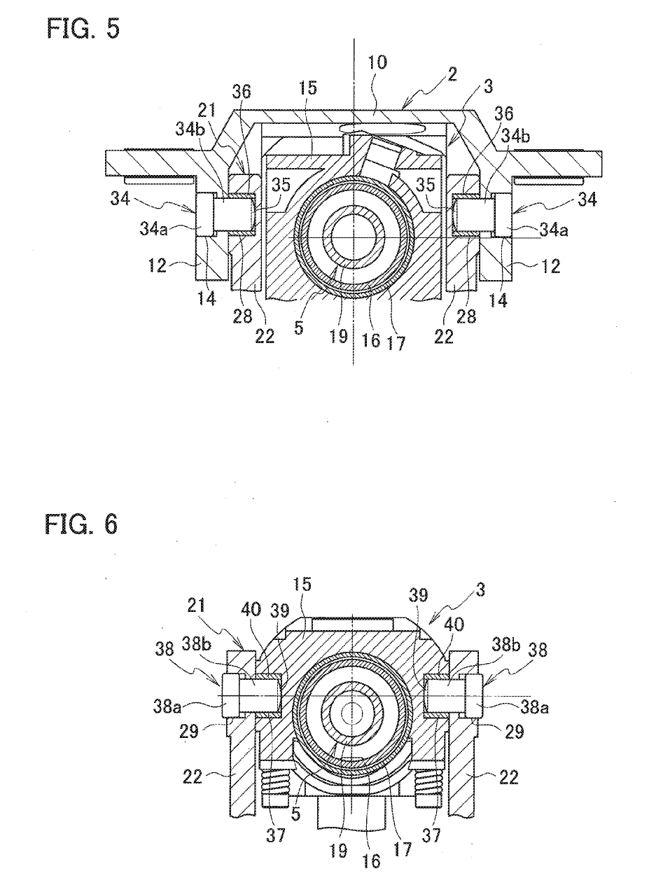

As illustrated in FIGS. 2 and 5, the first through holes 14 are formed in the side walls 12 of the vehicle-body mounting bracket 2, and the first bottomed holes 28 having the same axis as the first through holes 14 and opposed thereto are formed at the first connecting portions 24 of the link bodies 22. The base 34a of a pin (first pin) 34 is fixed (threadedly fixed) to the first through hole 14, the distal end portion 34b of the first pin 34 is inserted into the first bottomed hole 28, and the distal end portion 34b of the first pin 34 is pressed against the bottom surface of the first bottomed hole 28. To threadedly fix the base 34a of the first pin 34 to the first through hole 14, the base 34a of the first pin 34 and the large diameter portion of the first through hole 14 are threaded (subjected to a threading process). To prevent loosening of the first pin 34, for example, thread-locking fluid, caulking, or the like is used. The first pin 34 has a protrusion (first protrusion) 35 with an arcuate cross section (in a hemispherical shape) at the distal end portion 34b thereof, and the distal end of the first protrusion 35 is pressed against the bottom surface of the first bottomed hole 28. In other words, the first pin 34 is pressed against the bottom surface of the first bottomed hole 28 on the center axis of the first pin 34. Between the inner peripheral surface of the first bottomed hole 28 and the outer peripheral surface of the distal end portion 34b of the first pin 34 is interposed a bearing (first bearing) 36. The first pin 34 is, for example, a metal pin formed of metal material. The first bearing 36 is, for example, a needle bearing.

As illustrated in FIGS. 2 and 6, at the second connecting portions 25 of the link bodies 22 are formed the second through holes 29, and in the outer jacket 15 of the steering column 3 are formed bottomed holes (second bottomed holes) 37 having the same axis as the second through holes 29 and opposed thereto. The base 38a of a pin (second pin) 38 is fixed (threadedly fixed) to the second through hole 29, the distal end portion 38b of the second pin 38 is inserted into the second bottomed hole 37, and the distal end portion 38b of the second pin 38 is pressed against the bottom surface of the second bottomed hole 37. To threadedly fix the base 38a of the second pin 38 to the second through hole 29, the base 38a of the second pin 38 and the large diameter portion of the second through hole 29 are threaded (subjected to a threading process). To prevent loosening of the second pin 38, for example, thread-locking fluid, caulking, or the like is used. The second pin 38 has a protrusion (second protrusion) 39 with a arcuate cross section (in a hemispherical shape) at the distal end portion 38b thereof, and the distal end of the second protrusion 39 is pressed against the bottom surface of the second bottomed hole 37. In other words, the second pin 38 is pressed against the bottom surface of the second bottomed hole 37 on the center axis of the second pin 38. Between the inner peripheral surface of the second bottomed hole 37 and the outer peripheral surface of the distal end portion 38b of the second pin 38 is interposed a bearing (second bearing) 40. The second pin 38 is, for example, a metal pin formed of metal material. The second bearing 40 is, for example, a needle bearing.

As illustrated in FIGS. 2 and 3, at the third connecting portion 27 of the link body 22, the screw nut 30 is rotatably supported on the axis in the right-left direction, and the screw shaft 26 of the electric motor 6 is threadedly engaged with this screw nut 30.

Next, the swing support portion 11 of the steering column 3 will be described.

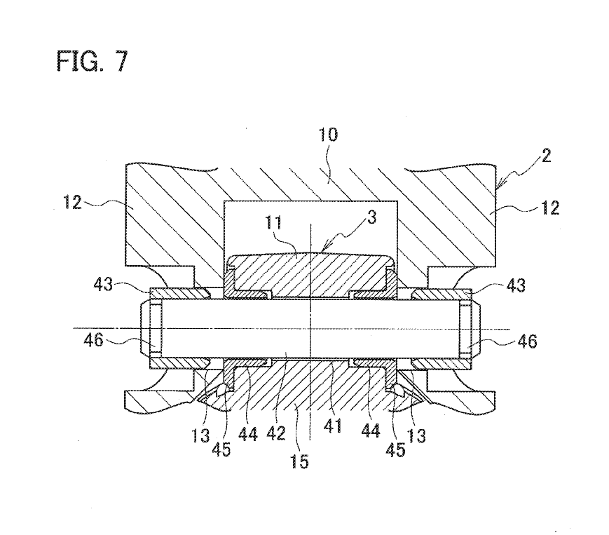

As illustrated in FIGS. 2 and 7, at the swing support portion 11 of the steering column 3 (outer jacket 15) is formed a through hole (column through hole) 41 passing through in the right-left direction. In addition, in the side walls 12 of the vehicle-body mounting bracket 2 are formed support holes 13 having the same axis as the column through hole 41 and opposed thereto. Into the support holes 13 and the column through hole 41 is inserted a shaft pin 42, and between the outer peripheral surface of each end portion of the shaft pin 42 and the inner peripheral surface of the support hole 13 is interposed a collar member 43. The inner end surface of the collar member 43 faces a bush 44 or flange 45 described later with a gap in between so as to be capable of being in contact with the bush 44 or flange 45. At each end of the shaft pin 42 is formed a circumferential groove 46, and the collar member 43 has an engagement protrusion 47 (see FIG. 2) which is engaged with the circumferential groove 46. Note that the circumferential groove 46 may be formed at only one end of the shaft pin 42, and the other end of the shaft pin 42 may have a flange integrally formed in the shape of the collar member 43. The shaft pin 42 is, for example, a metal pin formed of metal material. The collar member 43 is, for example, a resin collar formed of plastic.

The support holes 13 are elongated holes extending in the vehicle front-rear direction (the axial direction of the steering column 3), and the collar members 43 are supported to be slidable in the vehicle front-rear direction (the axial direction of the steering column 3) with respect to the support holes 13. The collar member 43 is formed as a C-shaped collar and is pressed against the inner surface of the support hole 13 by the elastic force of the collar member 43. The collar members 43 moves in the extending direction of the elongated holes together with the steering column 3, which absorbs the locus difference between the tilt rotation center (shaft pin 42) and the link rotation center (first pin 34) at the time when the steering column 3 is tilted.

Further, the bushes 44 are interposed between the inner peripheral surface of the column through hole 41 and the outer peripheral surface of the shaft pin 42. In addition, between the inner surface of each side wall 12 of the vehicle-body mounting bracket 2 and the side surface of the swing support portion 11 of the steering column 3 (outer jacket 15) is interposed the flange 45 integrally formed with the end of the bush 44. The bush 44 and the flange 45 are formed of, for example, metal material or plastic material.

In the electric steering column apparatus 1 of this embodiment, the electric motor 6 pushes or pulls the third connecting portion 27 of the link member 21 to swing the second connecting portions 25 in the vehicle up-down direction with the first connecting portions 24 (first pins 34) of the link member 21 as the rotational fulcrum. This swing operation swings the steering column 3 in the vehicle up-down direction with the tilt axis (shaft pin 42) disposed on the front side of the vehicle as the rotational fulcrum to adjust the tilt position of the steering wheel 4.

Hereinafter, the operational effect of this embodiment will be described.

(1) The electric steering column apparatus 1 includes the vehicle-body mounting bracket 2, the steering column 3 swingably supported by the vehicle-body mounting bracket 2, and the tilt mechanism 7 driven by the electric motor 6. The tilt mechanism 7 has the link member 21 connecting the vehicle-body mounting bracket 2 and the steering column 3 to each other. The link member 21 integrally has a pair of link bodies 22, 22 disposed at both sides of the steering column 3 in the width direction and the linkage portion 23 linking the link bodies 22, 22 to each other. Each link body 22 has the first connecting portion 24 to which the vehicle-body mounting bracket 2 is connected, the second connecting portion 25 to which the steering column 3 is connected, and the third connecting portion 27 to which the shaft portion (screw shaft 26) of the electric motor 6 is connected. The first through holes 14 are formed in the vehicle-body mounting bracket 2, and the first bottomed holes 28 facing the first through holes 14 are formed at the first connecting portions 24 of the link bodies 22. The base 34a of the first pin 34 is fixed to each first through hole 14, the distal end portion 34b of the first pin 34 is inserted into the first bottomed hole 28, and the distal end portion 34b of the first pin 34 is pressed against the bottom surface of the first bottomed hole 28. The second through holes 29 are formed at the second connecting portions 25 of the link bodies 22, and the second bottomed holes 37 facing the second through holes 29 are formed on the steering column 3. The base 38a of the second pin 38 is fixed to each second through hole 29, the distal end portion 38b of the second pin 38 is inserted into the second bottomed hole 37, and the distal end portion 38b of second pin 38 is pressed against the bottom surface of the second bottomed hole 37.

In the electric steering column apparatus 1, the pair of link bodies 22, 22 and the linkage portion 23 are integrated to make the link member 21 a rigid body. The distal end portion 34b of the first pin 34, which serves as the rotational fulcrum of the link member 21, is pressed against the bottom surface of the first bottomed hole 28 of the link member 21, and the distal end portion 38b of the second pin 38 is pressed against the bottom surface of the second bottomed hole 37 of the steering column 3. The tilt mechanism 7 thus configured suppresses increase in the rotational resistance of the link member 21 without increasing the part count, also improves the rigidity of the steering column 3 in the right-left direction, and prevents play in the right-left direction.

Accordingly, the electric steering column apparatus 1 according to this embodiment has improved rigidity of the steering column 3 in the right-left direction and a simplified structure, and improves the ease of assembly.

(2) The first pin 34 has the first protrusion 35 with an arcuate cross section at the distal end portion 34b, and the distal end of the first protrusion 35 is pressed against the bottom surface of the first bottomed hole 28. The second pin 38 has the second protrusion 39 with an arcuate cross section at the distal end portion 38b, and the distal end of the second protrusion 39 is pressed against the bottom surface of the second bottomed hole 37.

The first pins 34 and the first bottomed holes 28 are in point contact on the rotational center to reduce the sliding resistance, the second pins 38 and the second bottomed holes 37 are in point contact on the rotational center to reduce the sliding resistance. This structure is capable of reducing the rotational resistance of the link member 21.

(3) The first bearing 36 is interposed between the inner peripheral surface of the first bottomed hole 28 and the outer peripheral surface of the distal end portion 34b of the first pin 34, and the second bearing 40 is interposed between the inner peripheral surface of the second bottomed hole 37 and the outer peripheral surface of the distal end portion 38b of the second pin 38.

The sliding resistance between the first pin 34 and the first bottomed hole 28 is reduced by the first bearing 36, and the sliding resistance between the second pin 38 and the second bottomed hole 37 is reduced by the second bearing 40. This structure is capable of reducing the rotational resistance of the link member 21.

(4) The link member 21 is composed of an aluminum cast product.

This configuration achieves sufficient support rigidity of the steering column 3, using the link member 21 and suppresses a significant weight increase of the link member 21.

(5) The electric steering column apparatus 1 includes the vehicle-body mounting bracket 2, the steering column 3 swingably supported by the vehicle-body mounting bracket 2, and the tilt mechanism 7 driven by the electric motor 6. The vehicle-body mounting bracket 2 integrally includes the bracket body 10 and the pair of side walls 12, 12 extending from with the bracket body 10 and disposed on both right and left sides of the swing support portion 11 of the steering column 3. The column through hole 41 passing through in the right-left direction is formed at the swing support portion 11 of the steering column 3, and the support holes 13 facing to the column through hole 41 are formed in the side walls 12 of the vehicle-body mounting bracket 2. The shaft pin 42 is inserted into the support holes 13 and the column through hole 41, and the collar member 43 is interposed between the outer peripheral surface of at least one end portion of the shaft pin 42 and the inner peripheral surface of the support hole 13. The circumferential groove 46 is formed at least at one end portion of the shaft pin 42, and the engagement protrusion 47 engaged with the circumferential groove 46 is formed on the collar member 43.

In the electric steering column apparatus 1, the pair of side walls 12, 12 and the bracket body 10 are integrated to make the vehicle-body mounting bracket 2 a rigid body. In addition, the swing support portion 11 can be assembled only by inserting the shaft pin 42, which serves as the rotational fulcrum of the steering column 3, into the support holes 13 and the column through hole 41 and attaching the collar member 43 to an end portion of the shaft pin 42. This configuration of the swing support portion 11 of the steering column 3 improves the ease of assembly without increasing the part count.

Thus, the electric steering column apparatus 1 according to this embodiment has a simplified structure of the tilt axis (pivot axis) and improves the ease of assembly.

(6) The support holes 13 are elongated holes extending in the axis direction of the steering column 3, and the collar members 43 are supported to be slidable in the axis direction of the steering column 3 with respect to the support holes 13.

Although this structure allows the tilt axis (shaft pin 42) to move in the axis direction of the steering column 3, it is possible to achieve a relatively simple shaft support structure.

(7) The bush 44 is interposed between the inner peripheral surface of the column through hole 41 and the outer peripheral surface of the shaft pin 42, and the flange 45 formed at the end portion of the bush 44 is interposed between the inner side surface of the side wall 12 and the side surface of the swing support portion 11.

This configuration prevents play between the vehicle-body mounting bracket 2 and the steering column 3.

An electric steering column apparatus according to the present invention has been described using the foregoing embodiment as an example; however, the present invention is not limited to this embodiment but can employ other various embodiments without departing from the gist of the present invention.

What is claimed is:

1. An electric steering column apparatus comprising:
a vehicle-body mounting bracket;
a steering column swingably supported by the vehicle-body mounting bracket; and
a tilt mechanism driven by an electric motor, wherein
the tilt mechanism has a link member connecting the vehicle-body mounting bracket and the steering column to each other,
the link member integrally has a pair of link bodies disposed on both right and left sides of the steering column and a linkage portion linking the link bodies to each other,
the link bodies have a first connecting portion to which the vehicle-body mounting bracket is connected, a second connecting portion to which the steering column is connected, and a third connecting portion to which a shaft portion of the electric motor is connected,
a first through hole is formed in the vehicle-body mounting bracket, and a first bottomed hole facing the first through hole is formed at the first connecting portion of the link bodies,
a base of a first pin is fixed to the first through hole, a distal end portion of the first pin is inserted into the first bottomed hole, and the distal end portion of the first pin is pressed against a bottom surface of the first bottomed hole,
a second through hole is formed at the second connecting portion of the link bodies, and a second bottomed hole facing the second through hole is formed on the steering column, and
a base of a second pin is fixed to the second through hole, a distal end portion of the second pin is inserted into the second bottomed hole, and the distal end portion of the second pin is pressed against a bottom surface of the second bottomed hole.

2. The electric steering column apparatus according to claim 1, wherein
the first pin has a first protrusion with an arcuate cross section at the distal end portion of the first pin, and a distal end of the first protrusion is pressed against the bottom surface of the first bottomed hole, and
the second pin has a second protrusion with an arcuate cross section at the distal end portion of the second pin, and a distal end of the second protrusion is pressed against the bottom surface of the second bottomed hole.

3. The electric steering column apparatus according to claim 1, wherein
a first bearing is interposed between an inner peripheral surface of the first bottomed hole and an outer peripheral surface of the distal end portion of the first pin, and
a second bearing is interposed between an inner peripheral surface of the second bottomed hole and an outer peripheral surface of the distal end portion of the second pin.

4. The electric steering column apparatus according to claim 1, wherein
the link member is composed of an aluminum cast product.

5. An electric steering column apparatus comprising:
a vehicle-body mounting bracket;
a steering column swingably supported by the vehicle-body mounting bracket; and
a tilt mechanism driven by an electric motor, wherein
the vehicle-body mounting bracket integrally has a bracket body and a pair of side walls extending from the bracket body and disposed both right and left sides of a swing support portion of the steering column,
a column through hole is formed at the swing support portion of the steering column so as to pass through the swing support portion in a right-left direction, a support hole facing the column through hole is formed in each of the side walls of the vehicle-body mounting bracket, a shaft pin is inserted into the support holes and the column through hole, and a collar member is interposed between an outer peripheral surface of at least one end portion of the shaft pin and an inner peripheral surface of the corresponding support hole, and
a circumferential groove is formed at least at one end portion of the shaft pin, and an engagement protrusion engaged with the circumferential groove is formed on the collar member.

6. The electric steering column apparatus according to claim 5, wherein
the support holes are elongated holes extending in an axial direction of the steering column, and
the collar member is supported to be slidable in the axial direction of the steering column with respect to the support holes.

7. The electric steering column apparatus according to claim 5, wherein
a bush is interposed between an inner peripheral surface of the column through hole and the outer peripheral surface of the shaft pin, and a flange formed at an end portion of the bush is interposed between an inner side surface of the corresponding side wall and a side surface of the swing support portion.
